(19) United States
(12) Patent Application Publication
(10) Pub. No.: US 2024/0238734 A1
(43) Pub. Date: Jul. 18, 2024

(54) SYSTEM FOR UNDERGROUND AIR RELEASE FROM UNDERGROUND PIPELINES

(71) Applicant: MEKOROT WATER COMPANY LTD, Tel-Aviv (IL)

(72) Inventors: Mordechay SHIRI, Ashkelon (IL); Elena GELMAN, Rehovot (IL); Levy FRENKEL, Ashkelon (IL); Sivan BLEICH, Pardes Hanna-Karkour (IL); Moshe SORECK, Herzliya (IL); Igor PAKER, Rosh Haayin (IL); Oded SUED, Atzmon Segev (IL); Yael Helfman-Cohen, Zichron Yaakov (IL); Tomer Levi, Kibbitz Tlalim (IL); Aharon Pinhas, Be'er Sheva (IL)

(21) Appl. No.: 18/565,557

(22) PCT Filed: Jun. 1, 2022
(86) PCT No.: PCT/IL2022/050579

§ 371 Date: Nov. 30, 2023

Related U.S. Application Data
(60) Provisional application No. 63/196,232, filed on Jun. 3, 2021.

(51) Int. Cl. B01D 69/02; B01D 69/10

(52) U.S. Cl. CPC B01D 69/02; B01D 69/10; B01D 2325/02832; B01D 2325/04; B01D 2325/38

(57) ABSTRACT

The invention provides a system for underground release of air or gas from underground pipelines. The system comprises a selectively permeable membrane, located underground and secured in fluid and vapor communication with an underground pipeline. The selectively permeable membrane allows passage of air and gas therethrough, while substantially prevents passage of aqueous fluids therethrough.

### FIELD OF THE INVENTION

The invention broadly relates to structural elements for water and wastewater, and more particularly, relates to a means to eliminate air or gasses from within underground pipelines. Non-limiting examples of underground pipelines are water pipelines and wastewater pipelines.

### BACKGROUND

Water pipes and wastewater pipes are typically placed underground, to allow water delivery to all end consumers, and allow removal of wastewater. Underground placement protects pipes from tampering or damage and prevents waste of expensive real-estate area in urban areas, for pipe structures.

During active water pumping for water delivery, and especially when the terrain is not level, unwanted dissolved air, is released into the water pipes. The presence of air effectively lowers the volume of the pipe lumen and creates air whirlpools that represent considerable energy loss for water authorities. Air eddies lower the efficiency of pumping equipment, and damage sensors.

Prior art methods for removing air from within underground pipes, require installation of numerous automatic air release valves at set distances along the pipeline. The specialized air release valves are mounted on aboveground vertical pipes, as shown in Prior Art FIG. 1. The aboveground vertical pipe portions are undesirable in crowded urban environments: they are typically placed recurrently every 700-1000 meters upon the pipeline, and typically take up an area of at least six m², including fencing or enclosure to prevent vandalism or tampering. It would be preferable to avoid this waste of marketable space and allow placement of structures that are more aesthetic than air release valves.

The need exists for a method of air or gas release from underground pipelines, to minimize installation of aboveground air release valves.

Remote Prior Art from other fields: One-way permeable membranes have been used in unrelated fields, such as in cardiopulmonary bypass machines, for disinfection of solutions, and for adding moisture for indoor climate control. However, these materials have not been used to date in water pipelines, for underground air/gas release, along the length of the pipeline. Additionally, most selectively permeable membranes cannot withstand the high liquid entry pressure that is found in high pressure water mains, therefore requiring extensive experimentation to develop the present invention.

### SUMMARY OF THE INVENTION

In a general overview of the invention, the present invention provides a means and a method to release trapped air from underground high pressure pipelines (such as water and wastewater pipelines). The invention alleviates the prior art need for external and often expensive, above ground pipe valves and fittings, that require maintenance and protection from vandalism and theft.

The invention provides a system for underground release of air or gas from underground pipelines, comprising:
a selectively permeable membrane, located underground and secured in fluid and vapor communication with an underground pipeline, wherein the selectively permeable membrane allows passage of air and gas therethrough, while substantially prevents passage of aqueous fluids therethrough.

Optionally, the selectively permeable membrane is secured parallel to the plane of the underground pipeline.

In one embodiment, the selectively permeable membrane is secured in place using an upper anchoring rim and a lowering anchoring rim, each of the anchoring rims having a lumen.

Moreover, in some embodiments the system includes a rigid conduit vertical to the underground pipeline, wherein the selectively permeable membrane is secured at an upper extremity of the rigid conduit, and the rigid conduit providing fluid and vapor communication between the underground pipeline and the selectively permeable membrane.

In a presently preferred embodiment, the selectively permeable membrane is located beneath ground at a depth of about 30-120 cm beneath the surface.

Optionally, the system further comprises a valve located beneath the selectively permeable membrane, wherein the valve may be closed during maintenance of the system, to prevent fluid leakage from within the pipeline.

Moreover, the system may further comprise a non-return valve allowing one-way entry of air into the system, without user intervention.

In one case, the selectively permeable membrane is a porous hydrophobic membrane. In a presently preferred embodiment, the selectively permeable membrane is formed of a material selected from: PVDF, PTFE, PDMS, VVHP, pPE, Chitin, Chitosan, PTFE, HDPE, and Pertex®. Optionally, the selectively permeable membrane has a contact angle greater than 90 degrees.

Optionally, the membrane has a mean pore size of 0.5-0.005 micron.

In one embodiment, the selectively permeable membrane has a thickness of 100-500 micron.

Further, in a presently preferred embodiment, the selectively permeable membrane can withstand pressure of 2-17 bar.

In some instances, the selectively permeable membrane is a non-porous gas separation membrane. In such case, the selectively permeable membrane may be a high free volume polymer material, optionally selected from: fluorinated polymers and polysilynes.

Further, the selectively permeable membrane may be coated to prevent vapor therethrough.

Still further, the selectively permeable membrane may be coated to improve mechanical durability.

In some cases, the selectively permeable membrane is coated to prevent biofouling, the coating selected from: antibacterial colloidal particles of silver; antibacterial colloidal particles of copper; carbon nanotubes; and anti-bacterial polypeptides.

Moreover, the system may further comprise a support member located above the selectively permeable membrane, wherein the support member provides mechanical reinforcement to the selectively permeable membrane; and the support member is selected from a support grid or a support sieve.

In a presently preferred embodiment, the selectively permeable membrane allows passage therethrough of at least one of: nitrogen, oxygen, argon, and carbon dioxide. Further, the pore size of the selectively permeable membrane may be such to allow gaseous flow through the membrane of approximately 0.25 L air/1″ pipe diameter/1 km pipe/day.

Still further, the selectively permeable membrane may be installed at recurring distances of 350-800 meters upon the pipeline.

Optionally, the system further comprises at least one sensor for detection of fluid leakage, and a mechanism for triggering closure of an isolation valve when a leak is detected.

In one embodiment, the selectively permeable membrane is integrated in the plane of the pipeline, and the membrane conforms to a rounded outer wall of the pipeline.

These and other advantages of the invention are described further in the Detailed Description of the invention hereinbelow.

### Glossary

In the present invention, the terms “air”, and “gas” are used interchangeably in relation to components that may pass through a selectively permeable membrane. These terms refer to components typically found in air, in any formulation, or in any phase of matter. One or more of such components may pass through a selectively permeable membrane. Non-limiting examples include: nitrogen, oxygen, argon, carbon dioxide, and trace components found in air.

In the present invention, the term “fluid communication” and “vapor communication”, are used to describe the relation between the selectively permeable membrane and the underground pipeline. These terms indicate that fluid, air or gas may flow bidirectionally between the underground pipeline and the underside of the selectively permeable membrane.

In the present invention, the term “aqueous fluid” refers to a solution in which the solvent is water; or refers to water in any degree of purity. Non-limiting examples include drinking water and wastewater.

### BRIEF DESCRIPTION OF THE DRAWINGS

The present invention is illustrated by way of example in the figures of the accompanying drawings, in which like references indicate similar elements and in which:

FIG. 1 is a Prior Art Aboveground Air Release Valve apparatus.

FIG. 2 is a perspective view of the system of the invention is shown.

FIG. 3 is a schematic side view showing airflow during use of the system of the invention.

FIG. 4 is an exploded view of the selectively permeable membrane component and its anchoring rim components.

FIG. 5 is an exploded view of an embodiment with a support sieve as the support member.

FIG. 6 is a schematic side view showing airflow through non-return valve when the central water pipeline is temporarily shut down.

FIG. 7 is a Detailed Datasheet for PTFE selectively permeable membranes used.

FIG. 8 is a Detailed Datasheet for Hydrophobic PVDF selectively permeable membranes used.

FIG. 9 is a perspective view of an alternative embodiment, in which the selectively permeable membrane is integrated into the plane of the central water pipeline.

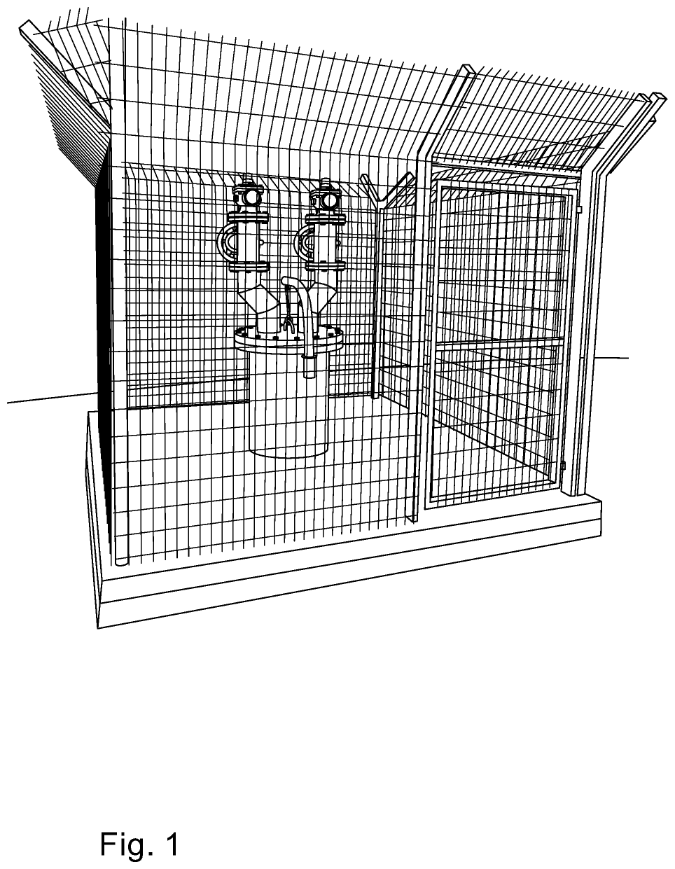

### DETAILED DESCRIPTION OF THE INVENTION

In the following detailed description, numerous specific details are set forth to provide a thorough understanding of the present invention. There is no intention to limit the invention to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

In a general overview, the system of the invention discloses novel use, of selectively permeable membranes, located recurrently along underground pipelines. The membranes allow continuous passive release of air or gasses therethrough, from within the pipeline, while preventing exit of water. Such membranes are placed and held underground, in fluid communication and/or vapor communication with the underground pipelines, to alleviate the need for aboveground air release, and thus grant savings in materials, space, and energy.

In the description below, the system of the invention is described in relation to municipal water pipelines that supply water for consumption. The system is not limited to this use and may be used to remove air or gasses from many other types of underground pipelines, including, but not limited to: wastewater pipelines, reclaimed water pipelines, desalination pipelines, or any underground pipeline.

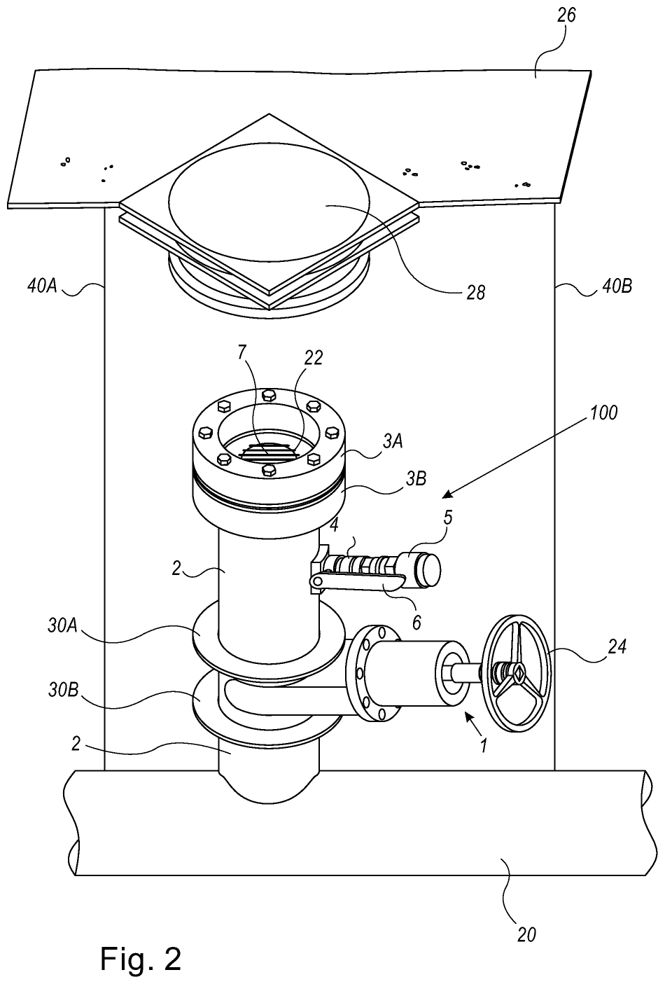

Referring to FIG. 2, a presently preferred embodiment of the system 100 is shown.

System 100 is located underground within dugout pit 40A, 40B, and may be accessed by removal of inspection cap 28 which is supported level to the surface 26.

Central Water Pipeline 20 is located underground, parallel to the surface 26, and acts to supply water to consumers.

Rigid conduit 2 provides fluid and vapor communication between Central Water Pipeline 20 and Selectively Permeable Membrane 7 (Membrane 7 is located near the upper extremity of the System 100).

Selectively Permeable Membrane 7 is held in place parallel to the Pipeline 20, by Upper and Lower Anchoring Rims (flanges with a lumen) 3A, 3B, respectively, and is supported by Support Grid 22. Lower Anchoring Rim 3B is welded onto Rigid Conduit 2.

Upper Anchoring Rim 3A is typically located beneath ground at a depth of about 30-120 cm beneath the surface 26.

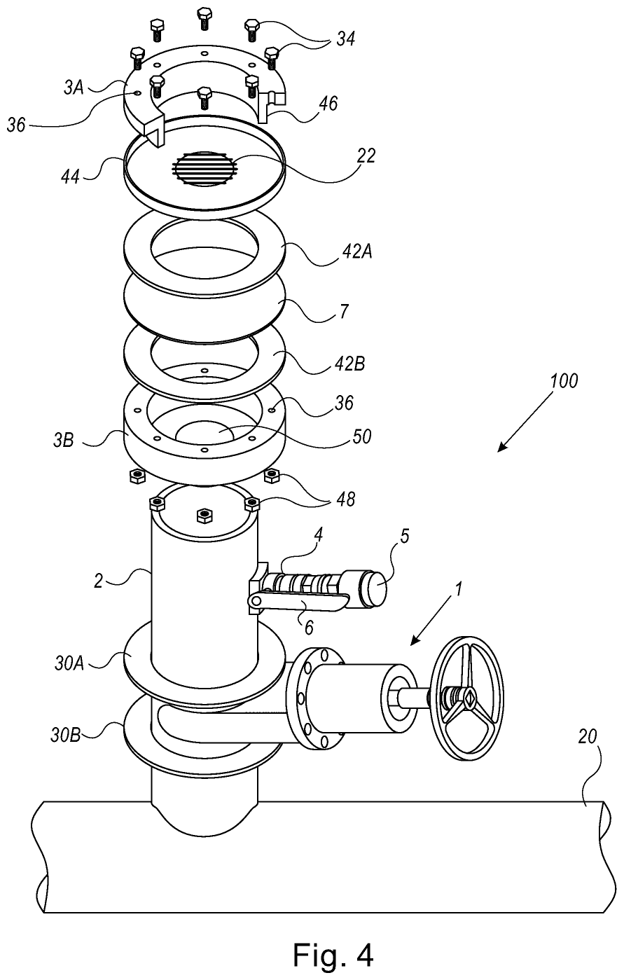

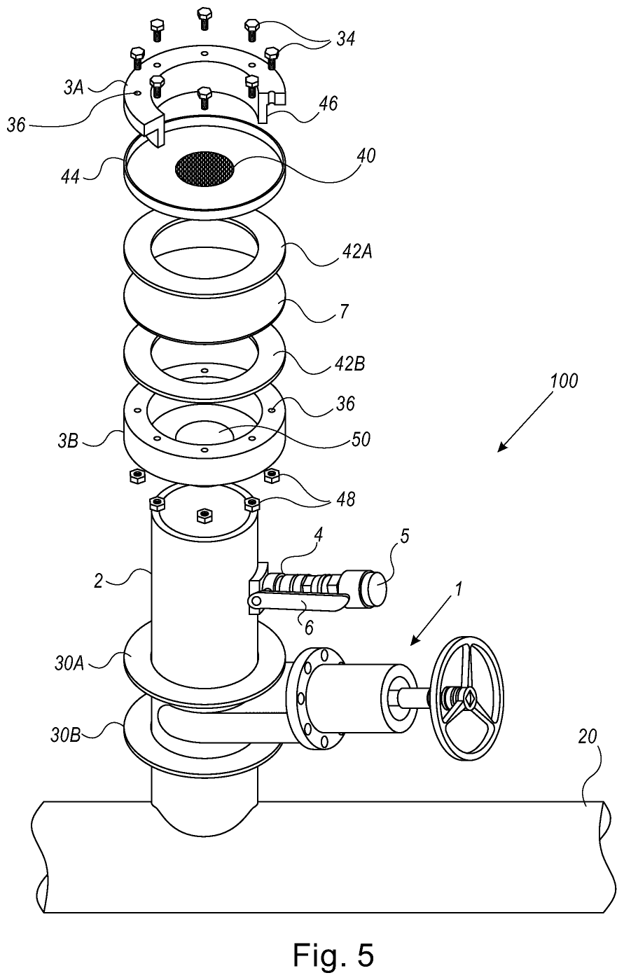

Membrane 7 and Anchoring Rims 3A, 3B are shown and described in detail in FIGS. 4-5 below.

Non-Return Valve 5 is mounted on the extremity of Lateral Pipe 4. Ball faucet 6 allows shutoff of flow, during maintenance of the non-return valve 5.

Valve 1 is fixed between upper and lower Supporting Flanges 30A, 30B. During operation of system, valve 1 remains open. However, handwheel 24 of valve 1 may be turned by a user in times of maintenance, to shutoff flow into rigid pipeline 2 from central water pipeline 20.

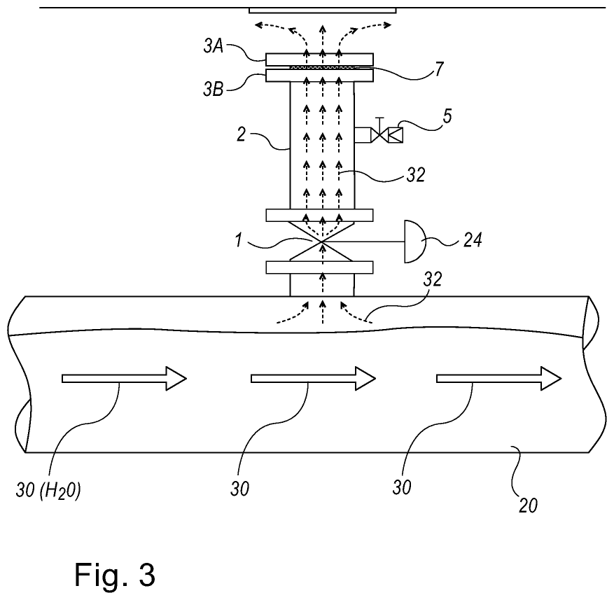

Referring now to FIG. 3, in use of system 100, water flows through Central Water Pipeline 20, in direction of Arrows 30.

When present, unwanted air or gas bubbles 32 (dashed arrows), will be forced by water pressure, upwards into Rigid Conduit 2, passed Valve 1, towards Selectively Permeable Membrane 7.

Due to the chemical and physical nature of Selectively Permeable Membrane 7 (enlarged upon below), air or gasses may exit through Selectively Permeable Membrane 7, while water is essentially prevented from exiting therethrough. Undesirable air or gasses are thus vented automatically and continuously as needed, below ground to the environment, via selectively permeable membrane, without waste of aboveground expensive real-estate.

Referring to FIG. 4, an exploded view is shown of Selectively Permeable Membrane 7 and Anchoring Rims 3A, 3B.

Membrane 7 is typically flaccid, having a typical thickness in the range of 100-500 micron.

In one embodiment, selectively permeable membrane 7 is a porous hydrophobic membrane (with a contact angle greater than 90 degrees). The mean pore size is 0.5-0.005 micron, such that the liquid water entry pressure as defined by the Young LaPlace or Kantor equation is greater than 4 bar, and in some cases can be as high as 17 bar. Materials that can form such membranes can include, but are not limited to, PVDF and PTFE.

In an alternative embodiment, selectively permeable membrane 7 is a non-porous gas separation membrane whose gas permeability is high enough to allow removal of any trapped air within one day. Membrane polymers that provide such properties are high free volume materials, including, but not be limited to, fluorinated polymers, or polysilynes such as PTMSP.

The underside of Membrane 7 may be coated to prevent passage of water vapor therethrough, or to improve mechanical durability and prevent tearing.

During deployment of system, Membrane 7 is placed between sealing O-rings 42A, 42B. These are then placed above Lower Anchoring Rim 3B, with center of Membrane 7 located in Lumen 50 of Anchoring Rim 3B.

Excess membrane at the periphery of Membrane 7 may optionally include perforations to receive Bolts 34. Alternatively, Membrane 7 may be sized to fit in Lumen 50 of Anchoring Rims 3A, 3B, with minimal excess at the circumference, such that clamping and bolting of Anchoring Rims 3A to 3B secures Membrane 7 in place without perforating the circumference of Membrane 7.

Support Grid 22 is placed above Membrane 7, to provide mechanical reinforcement for membrane and prevent adjacent earth from shifting and perforating the membrane. Rim wall 44 of Support Grid 22 mates with and clicks onto, Lower Wall 46 of Upper Anchoring Rim 3A.

Upper Anchoring Rim 3A is placed over Support Grid 22, and bolts 34 are introduced into Holes 36 on Anchoring Rims 3A, 3B. Bolts 34 are fastened using nuts 48, to clamp and hold Membrane 7 in place upon Rigid Conduit 2.

Selectively Permeable Membrane 7 is thus in fluid and vapor communication with the Rigid Conduit 2, with the underside of Membrane 7 placed above the lumen of Rigid Conduit, and the upper side of Membrane 7 facing towards the external environment (belowground).

A gap of 30-120 cm will typically be present between the upper side of Membrane 7 and the underside of inspection cap 28, allowing sufficient space for exit of air/gas into the underground environment.

The central water pipeline, rigid conduit, and lateral pipe are preferably made of steel (such as galvanized steel). The anchoring rims and support sieve or support grid, may be made of steel or plastic.

Referring to FIG. 5, in an alternative embodiment, support member is a Support Sieve 40 which replaces Support Grid 22 in supporting upper side of Membrane 7.

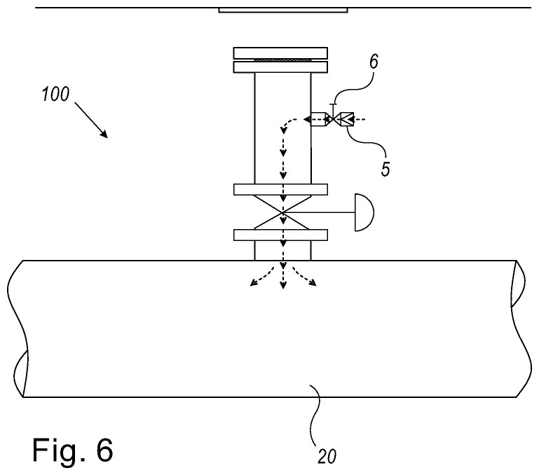

Referring to FIG. 6, Non-Return Valve 5 allows one-way entry of air into the system 100, without user intervention, in such instances as when the Central Water Pipeline 20 is temporarily shut down, or when a new pipeline is laid. Air entry in such cases will prevent generation of a vacuum and allow filling or refilling of central pipeline 20. Airflow is depicted as dashed arrows.

Ball faucet 6 typically remains in the open position and is only closed to shut off the flow when non-return valve 5 is checked for routine maintenance.

### Selectively Permeable Membranes

The selectively permeable membrane component preferably has the following features:

Non-toxicity, non-allergenic, and in accordance with dietary and health regulations for drinking water.

The membrane preferably has mechanical strength to withstand pressure of 2-17 Bar.

The membrane is preferably resistant to particles that may occur in the pipeline (e.g., sand, soil, building materials), so that buildup of these particles does not occur upon the membrane (which could clog membrane pores), and the membrane has sufficient tensile strength to withstand tearing due to the presence of these particles.

The membrane is preferably resistant to biofouling (buildup of microorganisms). Optionally, one or more external coatings are applied to the membrane for these purposes, such as: antibacterial colloidal particles of silver or copper, carbon nanotubes, or polypeptides having anti-bacterial properties.

The membrane is preferably resistant to corrosion, and pH resistant (able to withstand pH values of 5-9) and resistant to the presence of chlorine (typically found around 0.5 PPM). The surface texture of the membrane is designed to lower friction (which would result in energy loss); the smoothness should be similar to that acceptable in pipeline materials.

The air flux should preferably be maximal, so that maximal air/gasses from within the pipeline are released through the membrane to the surrounding environment, while exit of water is prevented by the one-way nature of the membrane.

In a presently preferred embodiment, the selectively permeable membrane allows passage therethrough of non-polar gasses in various forms (oxygen, nitrogen, and carbon dioxide), while substantially preventing exit of water vapor. Minute quantities of water may be discharged via the membrane.

In some embodiments, the membrane allows bidirectional passage therethrough of non-polar gasses. In other embodiments, the membrane allows passage therethrough and exit of such gases from the system, while preventing entry of such gasses from the external environment, into the system.

In one presently preferred embodiment, the pore size of said membrane is such to allow gaseous flow through the membrane of approximately 0.25 L air/1″ pipe diameter/1 km pipe/day.

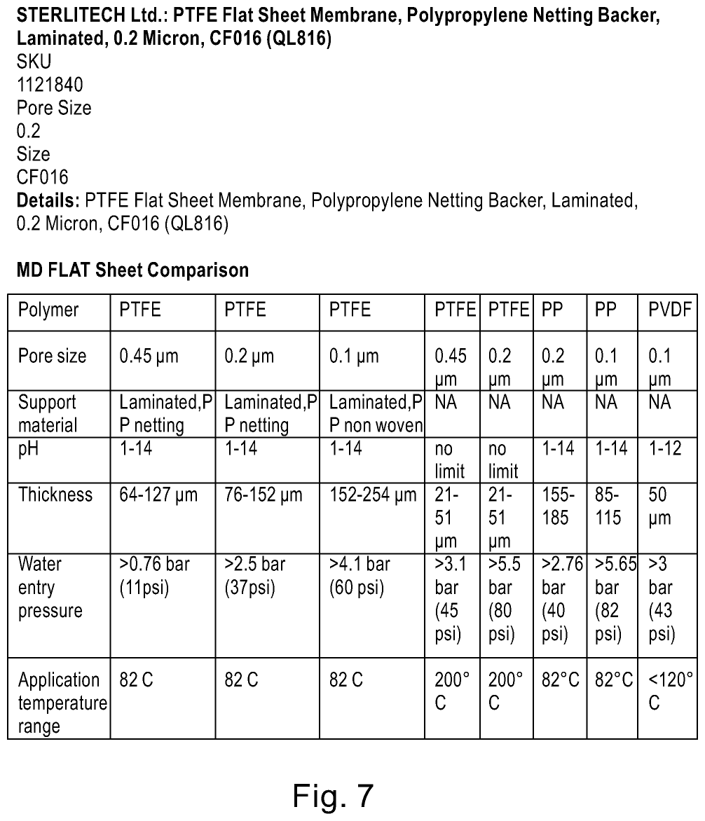

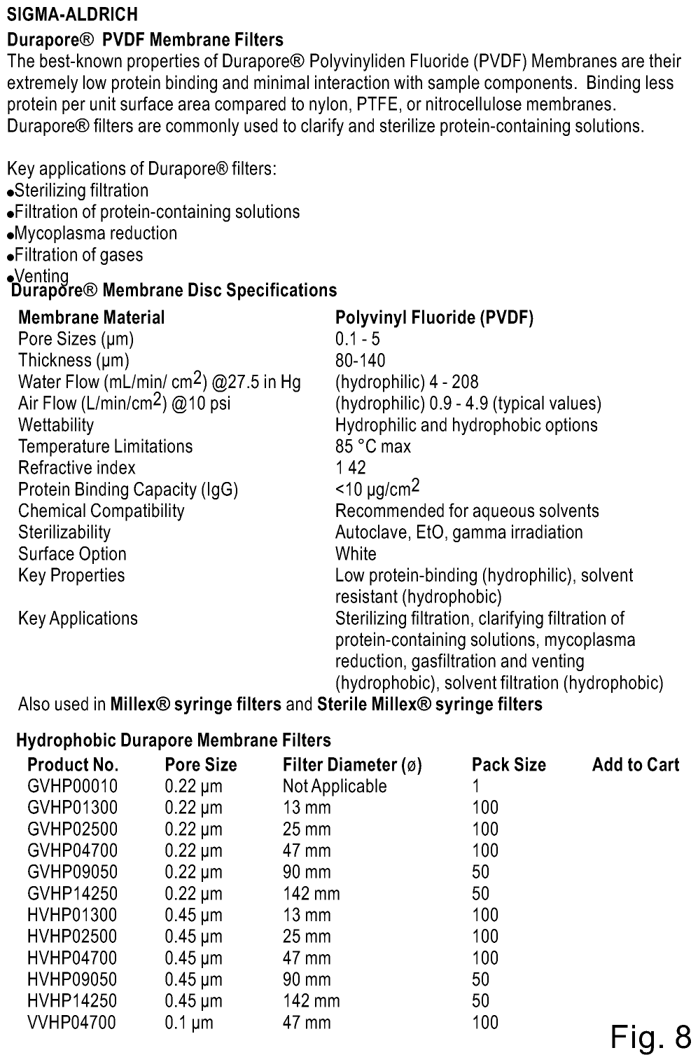

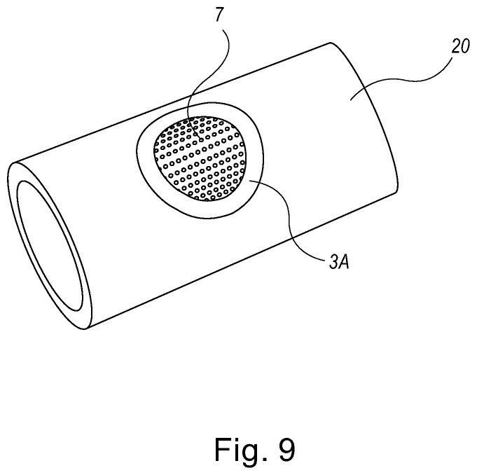

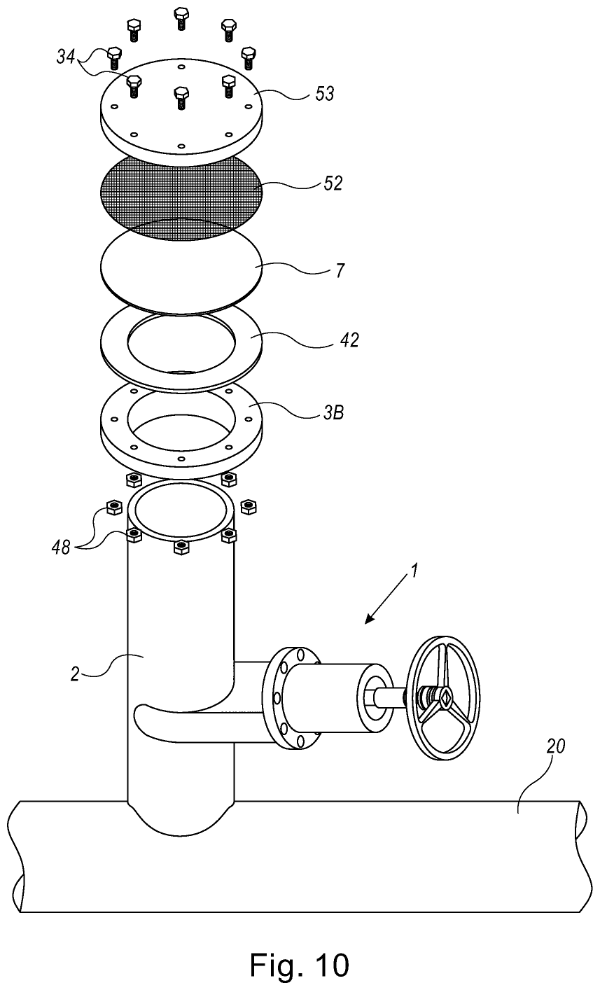

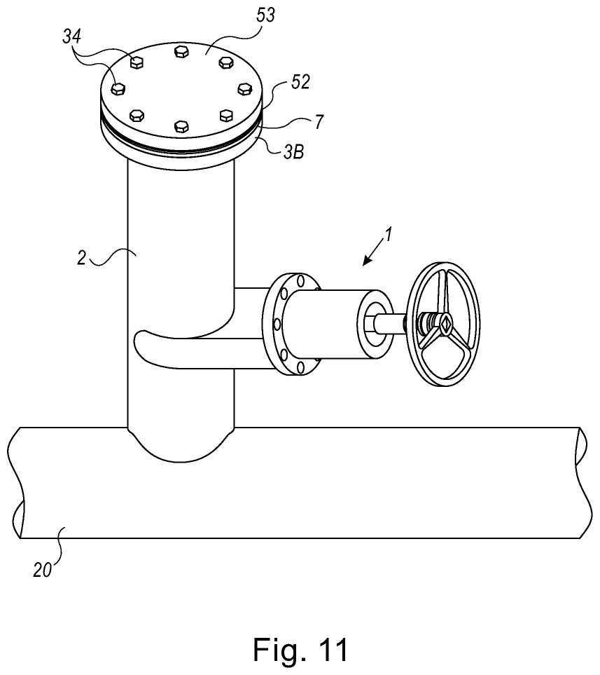

In a presently preferred embodiment, the following non-limiting materials were used as selectively permeable membranes:
1. Silicone-Based Membranes (PDMS):
   a) Flat Sheet SSP-M823 manufactured by SSP Ltd. of Ballston Spa, NY, USA.
   b) Hollow Fiber membranes (various pore sizes), manufactured by PermSelect Ltd. of Ann Arbor, MI, USA.
2. Teflon-type membranes (PTFE) such as those manufactured by Sterlitech Ltd. of Auburn, WA USA.
   Referring to FIG. 7, a Detailed Datasheet is shown, for presently preferred PTFE selectively permeable membranes manufactured by Sterlitech Ltd., having a minimal pore size (0.1 um).
   Another suitable membrane was Emflon® PTFE membrane, having a mean pore size of 0.02μ, with a size of about 20×25 cm, manufactured by Pall Corp. of Port Washington, USA.
3. Hydrophobic membranes (PVDF) manufactured by the Sigma-Aldrich subsidiary of Merck KGaA.
   Referring to FIG. 8, a Detailed Datasheet is shown, for presently preferred Hydrophobic PVDF selectively permeable membranes manufactured by Sigma-Aldrich subsidiary of Merck KGaA.
   One such example is VVHP—hydrophobic Durapore—pore diameter 0.1 um.
4. Porous Polyethylene (pPE) membranes manufactured by Rayon Co. Ltd. (Tokyo, Japan) Mitsubishi, which can withstand up to 10 Atm.

Many additional materials may be suitable for use as selectively permeable membranes (or coatings), including the following non-limiting examples:

Chitin or Chitosan, GoreTex manufactured by Gore (PTFE also known as ePTFE), Tyvek (made of HDPE fibers, manufactured by Dupont), PerTex manufactured by Mitsui & Co.

Non-porous membranes may be used, such as would be acceptable for gaseous separation, as these membranes can withstand pressures of up to 17 Bar. Examples include non-porous perfluorinated polymers, such as AF2400 manufactured by Compact Membrane Systems of Newport Delaware, USA.

According to a presently preferred embodiment, the selectively permeable membranes and remaining components of the system, are installed at recurring distances of 350-800 meters along the length of the pipeline.

When the diameter of the central water pipeline exceeds 24 inches, it may be necessary to install a cluster of selectively permeable membranes and associated system components. Alternatively, the distance between recurring units of the invention may be reduced, to be less than 350 meters between units.

In some instances, prior art aboveground air release valves mounted on aboveground vertical pipes, are installed, in conjunction with the system of the present invention. In such case, use of the system will reduce the number of aboveground air release pipes needed, as compared to the prior art.

The membrane may have various shapes and sizes. The membrane may be rigid or flaccid.

Optionally, the system may include sensors for detection of water leakage, and a mechanism for triggering closure of an isolation valve when a leak is detected.

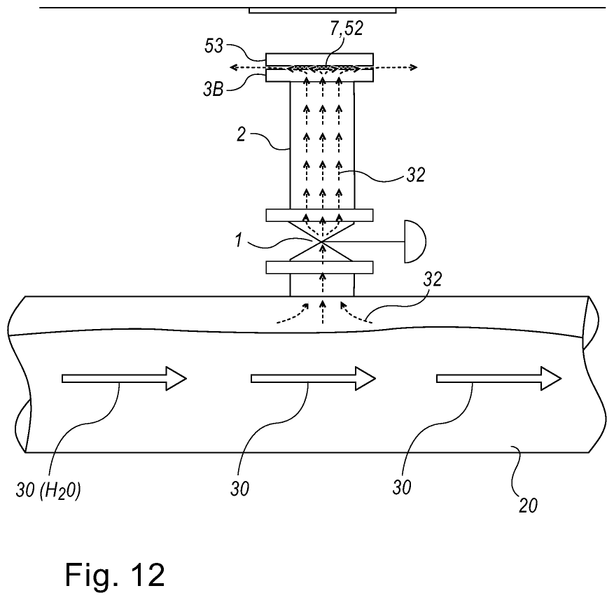

Referring to FIG. 9, in an alternative embodiment, the selectively permeable membrane 7 is integrated in the plane of the central water pipeline 20, where it is secured by anchoring rims 3A, 3B. In this embodiment, the membrane 7 is sufficiently flaccid to allow it to conform to the rounded outer wall of the pipeline 20.

### EXAMPLE

In order to project durability of the system after 5 years of use, the system of the invention, as described in relation to FIGS. 2-4, was installed upon a Central municipal water pipeline, using suitable connectors.

Central municipal water pipeline 20 is formed of galvanized steel. Rigid conduit is a galvanized steel pipe of 1.5 M length, having a diameter of 6 inches, terminating at its upper end with Lower Anchoring Rim (3B), which is welded to rigid conduit.

Anchoring Rims 3A and 3B will support the Selectively Permeable Membrane, once Anchoring Rims 3A, 3B are bolted together upon the membrane and its supporting elements: A Support Sieve 40 is the upper most element above the membrane, and an outer Support Grid 22 touches the upper side of the membrane and lies beneath the Support sieve 40.

Selectively Permeable Membrane is a Silicone-Based Membrane (PDMS) such as Flat Sheet SSP-M823, having a thickness of up to 0.040″, manufactured by SSP Ltd. of Ballston Spa, NY, USA.

Lateral Pipe 4 is formed of galvanized steel having a 2 inch diameter. Non-Return Valve is directed so that the direction of airflow is towards the system (as shown in FIG. 6). Non-Return Valve 5 is readily available commercially, as is Gate Valve 1.

A second lateral pipe 4 was included parallel to, and above the first lateral pipe, and attached to a manometer to measure the pressure in the system. Second lateral pipe and Manometer are for experimental purposes of the present Example, and are not included in the system when it is deployed in the field.

The durability of the membrane was tested. To simulate wear of 5 year usage, rigid conduit was repeatedly filled with 2 liters of water, and the pressure was raised to reach 4 Bar, and maintained for periods of 15 minutes. The water was then drained. This process was repeated thrice daily for a period of one month. At the end of this term, the pressure was raised to reach 9 Bar.

Results showed airflow was detected through the membrane, without water leakage during the duration tested. Results prove sufficient durability of the membrane, in conditions that simulate 5 years of deployment of the system in the field, at pressures of up to 9 Bar.

In summary, the system of the invention and its recurrent selectively permeable membranes, allow continuous passive release of air or gasses therethrough, underground, and alleviate the need for aboveground air release, thus granting savings in materials, space, and energy.

Having described the invention with regard to certain specific embodiments thereof, it is to be understood that the description is not meant as a limitation, as further modifications will now become apparent to those skilled in the art, and it is intended to cover such modifications as are within the scope of the appended claims.

1. A system for underground release of air or gas from underground pipelines, comprising:
a selectively permeable membrane, located underground and secured in fluid and vapor communication with an underground pipeline, wherein said selectively permeable membrane allows passage of air and gas therethrough, while substantially prevents passage of aqueous fluids therethrough.

2. The system of claim 1, wherein said selectively permeable membrane is secured parallel to the plane of said underground pipeline.

3. The system of claim 1, wherein said selectively permeable membrane is secured in place using an upper anchoring rim and a lowering anchoring rim, each of said anchoring rims having a lumen.

4. The system of claim 1, comprising a rigid conduit vertical to said underground pipeline, wherein said selectively permeable membrane is secured at an upper extremity of said rigid conduit, and said rigid conduit providing fluid and vapor communication between said underground pipeline and said selectively permeable membrane.

5. The system of claim 1, wherein said selectively permeable membrane is located beneath ground at a depth of about 30-120 cm beneath the surface.

6. The system of claim 1, further comprising a valve located beneath said selectively permeable membrane, wherein said valve may be closed during maintenance of said system, to prevent fluid leakage from within said pipeline.

7. The system of claim 1, further comprising a non-return valve allowing one-way entry of air into the system, without user intervention.

8. The system of claim 1, wherein said selectively permeable membrane is a porous hydrophobic membrane.

9. The system of claim 1, wherein said selectively permeable membrane is formed of a material selected from: PVDF, PTFE, PDMS, VVHP, PPE, Chitin, Chitosan, PTFE, HDPE, and Pertex®.

10. The system of claim 8, wherein said selectively permeable membrane has a contact angle greater than 90 degrees.

11. The system of claim 1, wherein said selectively permeable membrane has a mean pore size of 0.5-0.005 micron.

12. The system of claim 1, wherein said selectively permeable membrane has a thickness of 100-500 micron.

13. The system of claim 1, wherein said selectively permeable membrane is formed of at least one material and mechanical strength that can withstand pressure of 2-17 bar.

14. The system of claim 1, wherein said selectively permeable membrane is a non-porous separation membrane suitable for separation of gasses or of organic solvents.

15. The system of claim 14, wherein said selectively permeable membrane is a high free volume polymer material.

16. The system of claim 15, wherein said high free volume polymer material is selected from: fluorinated polymers and polysilynes.

17. The system of claim 1, wherein said selectively permeable membrane is coated to prevent vapor therethrough.

18. The system of claim 1, wherein said selectively permeable membrane is coated to improve mechanical durability.

19. The system of claim 1, wherein said selectively permeable membrane is coated to prevent biofouling, said coating selected from: antibacterial colloidal particles of silver; antibacterial colloidal particles of copper; carbon nanotubes; and anti-bacterial polypeptides.

20. The system of claim 1, further comprising a support member located above said selectively permeable membrane, wherein said support member provides mechanical reinforcement to said selectively permeable membrane; and said support member is selected from: a support grid, a support sieve, and a guard net.

21. The system of claim 1, wherein said selectively permeable membrane allows passage therethrough of nitrogen and at least one of: oxygen, argon, and carbon dioxide.

22. The system of claim 1, wherein said selectively permeable membrane is such to allow gaseous flow through the membrane of approximately 0.25 L air/1 km pipe/day, and wherein said membrane diameter is selected to provide said flow therethrough.

23. The system of claim 1, wherein said selectively permeable membrane is installed at recurring distances of 350-800 meters upon said pipeline.

24. The system of claim 1, further comprising at least one sensor for detection of fluid leakage, and a mechanism for triggering closure of an isolation valve when a leak is detected.

25. The system of claim 1, wherein said selectively permeable membrane is integrated in the plane of said pipeline, and said membrane conforms to a rounded outer wall of said pipeline.

26. The system of claim 1, wherein said selectively permeable membrane is secured in place using a blind flange.

27. The system of claim 14, wherein said membrane is a hydrophobic membrane essentially formed of PDMS (poly dimethylsiloxane), present as a thin film, and further comprises a coating for mechanical support.

28. The system of claim 1, wherein said membrane comprises a porous membrane having a pore size of less than 0.05 micron, and said membrane is coated with a nonporous gas-permeable coating.
